(19) United States
(12) Patent Application Publication
(10) Pub. No.: US 2013/0079936 A1
(43) Pub. Date: Mar. 28, 2013

(54) REMOTE ACCESS FOR WATER INFRASTRUCTURE MANAGEMENT

(71) Applicants: Brian Cullen, Costa Mesa, CA (US); Juergen Nick, Costa Mesa, CA (US)

(72) Inventors: Brian Cullen, Costa Mesa, CA (US); Juergen Nick, Costa Mesa, CA (US)

(21) Appl. No.: 13/615,283

(22) Filed: Sep. 13, 2012

Related U.S. Application Data
(60) Provisional application No. 61/534,312, filed on Sep. 13, 2011.

(51) Int. Cl. G05D 7/00

(52) U.S. Cl. 700/283

(57) ABSTRACT

A system for remotely monitoring and controlling a plurality of water treatment facilities distributed over a wide area includes: a plurality of interfaces configured to receive status information from the facilities and to transmit commands to control the facilities; a database for storing the status information; and a human machine interface configured to transmit the status information to a remote terminal.

### CROSS-REFERENCE TO RELATED APPLICATION

This application claims the benefit of U.S. Provisional Patent Application No. 61/534,312 “REMOTE ACCESS FOR WATER INFRASTRUCTURE MANAGEMENT,” filed in the United States Patent and Trademark Office on Sep. 13, 2011.

### BACKGROUND

1. Field

The described technology relates to software for managing water and wastewater infrastructure.

2. Description of Related Art

Water and wastewater treatment facilities are complex systems that demand efficient and precise operation and maintenance in order to produce highly regulated results, to reduce operational costs, and to generate safe water. However, the subsystems underlying these water and wastewater treatment facilities are generally operated and controlled by different people and separate interfaces which are generally poorly integrated. As such, monitoring, operating, and maintaining these systems can be difficult because, although the individual subsystems operate together to process the water, there is a need for a centralized interface that provides a holistic view of the interactions between the subsystems.

Generally, various databases are operated to store data collected throughout the lifecycle of the water treatment and management systems (e.g., during the course of standard design, build, own, operate, and finance processes). For example, the collected data may be related to: Project Management, Energy Management, Design, Finance and Accounting, Regulatory, Construction Management, Supervisory Control and Data Acquisition (SCADA) Control System, Operation and Maintenance, Laboratory Information Management, Human Resource Management, and Knowledge Management. Water treatment and management systems are often designed to run for about 50 years, and multiple repeated stages of design, permitting, and construction are common during this period in order to implement, for example, upgrades to the systems and comply with new regulations and quality standards.

This data is generally stored in underlying databases (e.g., SQL databases) which are closely associated with their original purposes. In many cases the underlying databases may be developed by a variety of third party software providers. This data generally remains isolated and usable only for the single purpose for which it was entered or collected.

In the physical realm the various subsystems involved in water treatment are highly interdependent and the behavior of one subsystem will impact the others. However, the standard condition for data is a set of disparate locations or “islands” in which these values are currently stored making it difficult to optimize the operation of either the physical infrastructure or the digital systems.

Traditional SCADA systems merely collect operations data, but this data typically must be digital and provided in real time to be collected by such systems.

### SUMMARY

Embodiments of the present invention are directed to systems and methods for integrating data from different subsystems related to water and wastewater treatment infrastructure and providing a unified interface for monitoring and managing these subsystems.

According to one embodiment of the present invention, a system for remotely monitoring and controlling a plurality of water treatment facilities distributed over a wide area includes: a plurality of interfaces configured to receive status information from the facilities and to transmit commands to control the facilities; a database for storing the status information; and a human machine interface configured to transmit the status information to a remote terminal.

The interfaces may be configured to communicate with a SCADA system of one of the facilities.

The system may be configured to store documentation regarding the plurality of facilities.

The human machine interface may be further configured to transmit the stored documentation to the remote terminal.

The human machine interface may be further configured to transmit combined data of more than one of the facilities to the remote terminal.

The human machine interface may be further configured to transmit historical data associated with the facilities to the remote terminal.

The human machine interface may be further configured to receive commands from the remote terminal and wherein the system is configured to transmit the received commands to a facility of the facilities.

The received commands may be adapted to control an asset at the facility and wherein the system is further configured to convert the received commands to a format corresponding to the asset at the facility.

The system may further include a converter for converting status information to a common format.

According to another embodiment of the present invention, a system for remotely monitoring and controlling a water treatment facility includes: a plurality of interfaces configured to communicate with the facility, to receive status information from the facility, and to transmit commands to control the facility; a database for storing the status information; a human machine interface configured to transmit the status information to a remote terminal.

According to another embodiment of the present invention, a method of remotely monitoring and controlling a plurality of facilities distributed over a wide area includes: receiving status information from the facilities; storing the status information; and transmitting the status information to a remote terminal.

The status information transmitted to the remote terminal may include data from more than one of the facilities.

The method may further include: receiving a command from the remote terminal to control a facility of the facilities; and sending the command to the facility of the facilities.

The method may further include converting the status information into a common format.

### BRIEF DESCRIPTION OF THE DRAWINGS

The accompanying drawings, together with the specification, illustrate exemplary embodiments of the present invention, and, together with the description, serve to explain the principles of the present invention.

FIG. 1 is a graphical illustration of interconnections between a central server or data warehouse which manages a plurality of subsystems according to one embodiment of the present invention.

FIG. 2 is a schematic diagram of a system including a central server connected to end user devices over the internet and connected to databases and SCADA systems over local area networks or the internet according to one embodiment of the present invention.

FIG. 3 is a flowchart illustrating a method of modifying data stored in the databases managed by the central server according to one embodiment of the present invention.

FIGS. 4A and 4B are flowcharts illustrating a method of logging into the central server according to one embodiment of the present invention.

FIG. 5 is a screenshot of a user management administrative interface according to one embodiment of the present invention.

FIG. 6 is a screenshot of a user permissions administrative interface according to one embodiment of the present invention.

FIG. 7 is a screenshot of a facility information administrative interface according to one embodiment of the present invention.

FIG. 8 is a screenshot of an interface for selecting a facility to monitor and control according to one embodiment of the present invention.

FIG. 9 is a screenshot of a facility monitoring and control menu according to one embodiment of the present invention.

FIG. 10 is a screenshot of a facility monitoring interface displayed on a tablet computer according to one embodiment of the present invention.

FIG. 11 is a screenshot of a facility dashboard according to one embodiment of the present invention.

FIG. 12 is a screenshot of an alert displayed on a smartphone according to one embodiment of the present invention.

### DETAILED DESCRIPTION

In the following detailed description, only certain exemplary embodiments of the present invention are shown and described, by way of illustration. As those skilled in the art would recognize, the invention may be embodied in many different forms and should not be construed as being limited to the embodiments set forth herein. Like reference numerals designate like elements throughout the specification.

Embodiments of the present invention are directed to systems for integrating a collection of underlying subsystems, where the systems enable infrastructure operators, engineers, construction staff, and other authorized parties to synthesize data streams from multiple subsystems, to access water infrastructure data, and to make system changes from remote locations in order to improve water quality results and reduce risk. The systems are accessible via the internet through web browsers or dedicated applications (e.g., applications running on mobile devices such as smartphones and tablets) to allow distributed or remote viewing. Static historic data as well as up to the minute dynamic values are both available to the user who will use the information to control the infrastructure's operation using the invention.

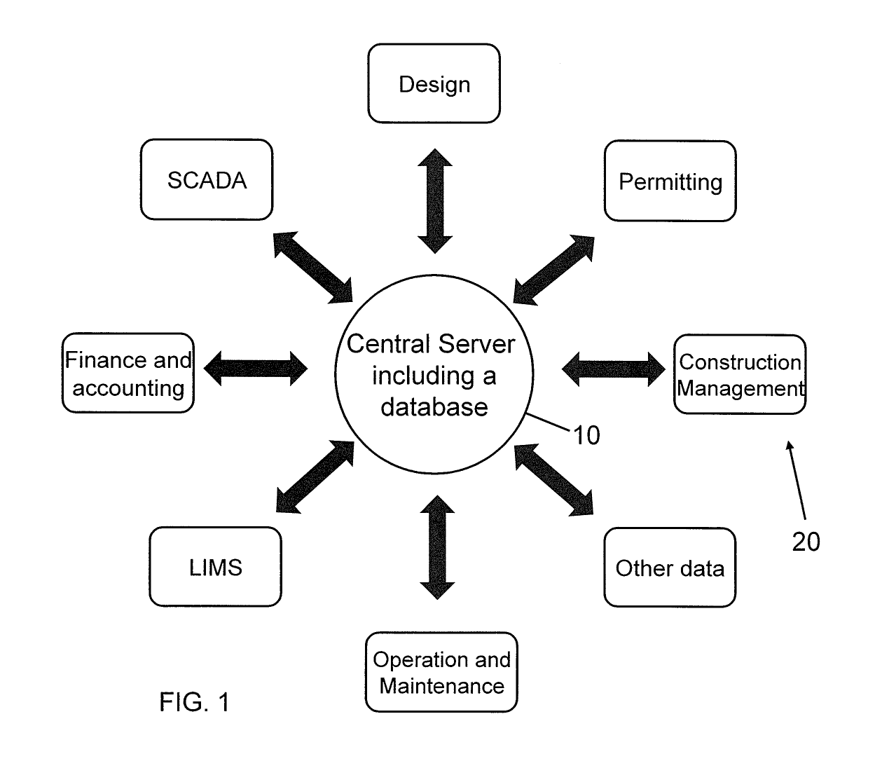

Referring to FIG. 1, in one embodiment of the present invention, a central server 10 (or group of servers) including a database (e.g., a SQL database) is used to store all information related to the management and control of the water infrastructure system, which allows data from various sources 20 (e.g., subsystems) to be combined, to interact, and to be available for interpretation in a more complete or holistic context. Most of the subsystems utilize the same or similar database formats, making information sharing possible. Sharing of information allows repetition of inputs to be reduced and increased transparency allows users to identify trends and to make educated predictions more easily.

In some embodiments of the present invention, these subsystems 20 include: design, energy management, permitting, operation, maintenance (CMMS), construction management, laboratory information systems (LIMS), finance and accounting, and SCADA. The design, subsystem manages, for example: customized design reports; cost models; equipment proposals; process models; drawings and models; and animation videos. The permitting subsystem manages, for example,: applications; official communications; operating permits; permit reports; and schedules. The operation subsystem manages, for example: daily observation reports; standard operating procedures; health and safety materials; and security systems. The maintenance subsystem manages, for example: equipment use records, maintenance logs & photos; schedules; warranties and replacement budgets. The construction management subsystem manages, for example: job site records; pictures; contracts and vendor information; and communication records. The laboratory information subsystem manages, for example: testing schedules; standard operating procedures; test results; calibration records; regulations and reference materials. The finance and accounting subsystem manages, for example: budgets, expenditures; and timesheets. The SCADA subsystem manages, for example: water constituents, equipment status; alarms; flow rates; and energy use.

When data from previously disparate locations can be presented together, the data are contextualized. Some examples include illustrating the actual effort put into maintaining equipment compared directly with the planned amount. The water quality results can be presented alongside pertinent regulations to determine compliance or compared with the quality results of similar facilities to measure competitiveness. Calculating treatment/production costs for producing a potable water or treating wastewater is possible with the full set of costs and water production values.

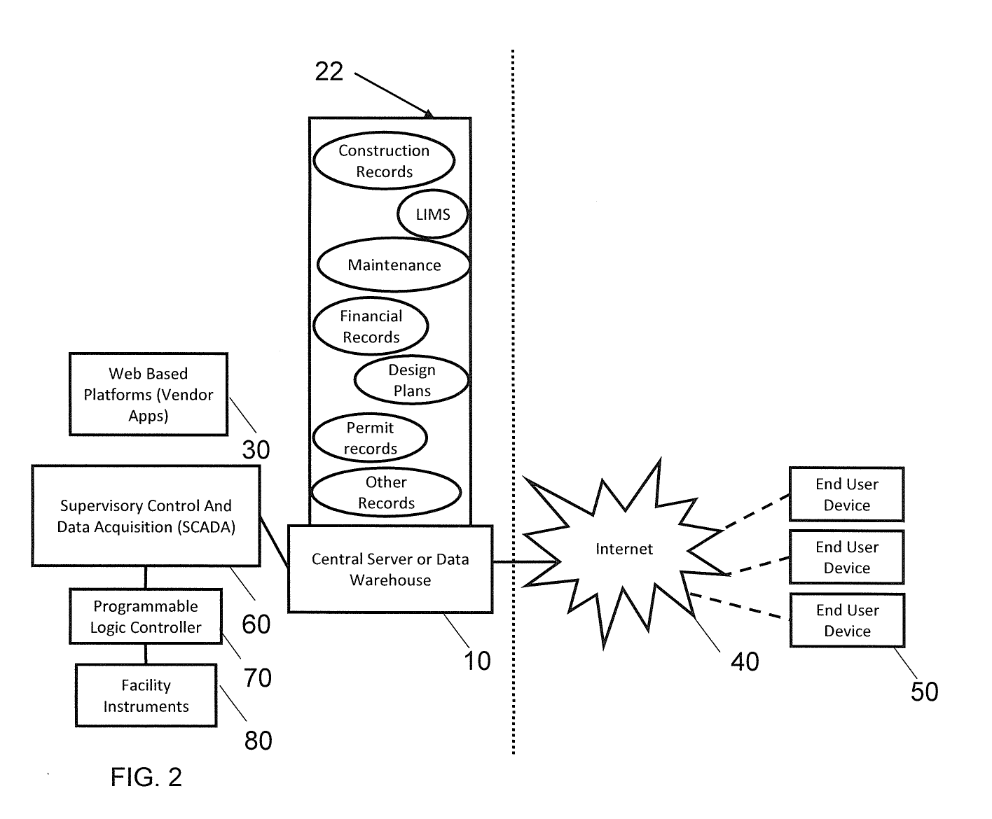

As shown in FIG. 2, in one embodiment, the central server 10 controls various subsystems 20 through various interfaces 22. The interfaces are connected to a SQL database (e.g., Microsoft® SQL Server®, MySQL, or PostgreSQL) which is connected to SCADA systems 60 which are connected to Programmable Logic Controllers 70.

In one embodiment of the present invention, the system is used with a mobile platform through Human Machine Interfaces (HMI or user interfaces) that are designed for use on portable and handheld devices. These human machine interfaces can have a dashboard-like look and feel and is used to display current conditions, historic data and reference material. The information that can be displayed can include, for example: energy use, equipment status, human resources information, and water quality. A focus on an intuitive, easy to use interface and consistent menus can improve the usability of these interfaces. The interface may be used to display, for example, analytics, graphs, and trends.

Access to the system to view the data and to control the subsystems may be governed by user authorization and authentication systems such as by providing a secure login interface. The login will dictate the content available for viewing based on the identity of the logged-in user.

During setup, a user selects their preferred display formats, prioritizes the display with information they find most useful and creates a secure password for their use.

In one embodiment of the present invention, the data is organized based on individual assets (e.g., individual pieces of equipment in the facility). For example, during facility design each proposed asset is given a unique identifier. With every decision made or action taken, an entry is made into a database (e.g., a Structured Query Language or SQL database) for storing this information. Water infrastructure system employees, municipal customers, and other authorized third parties can use this centrally stored information to improve their understanding and management of the facilities. The monitoring of each asset may identify, for example, overworked components, which give an early warning of eminent problems, and underutilized components, which may indicate that these components may no longer be necessary.

In another embodiment of the present invention, the data is organized by date and time. This organization around a sequence of events is appropriate for illustrating cause and effect and for documenting actions. Laboratory data, maintenance records, flow records, energy use, budgets and many other aspects of water infrastructure may be suited for organization in this way.

In another embodiment of the present invention, the data is organized by location. With the increasing use of Geographic Information Systems, the precise location of actions and physical assets can be identified. Tracking the location allows a user to return to a place and to relate events or assets to common infrastructure components such as collection systems and meter networks.

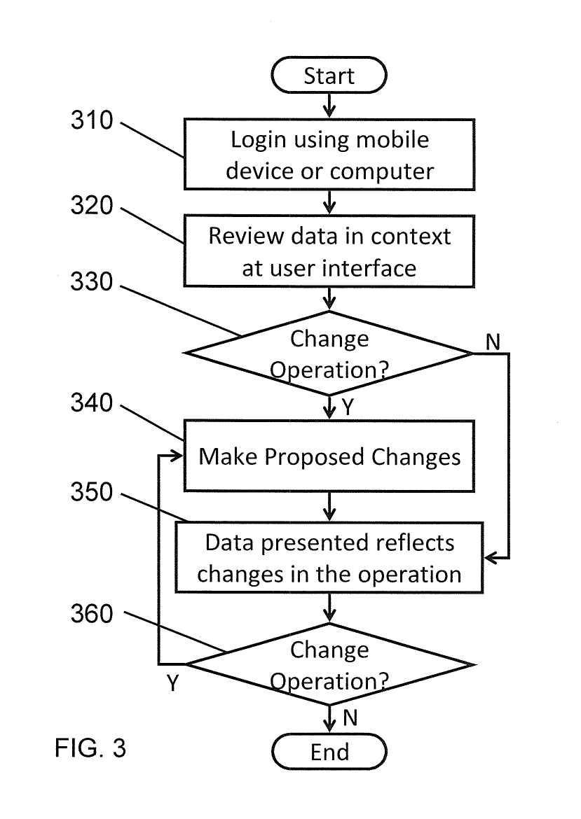

One method by which a user interacts with the system is shown in FIG. 3. A user can log in 310 using a mobile device or a computer and then review 320 the data regarding the status of various subsystems and facilities in context. If the user then selects an operation to change data 330, then appropriate changes are made 340 in the database 30. If new data needs to be added manually 350, then new data is uploaded 360 to the system and stored in the database 30.

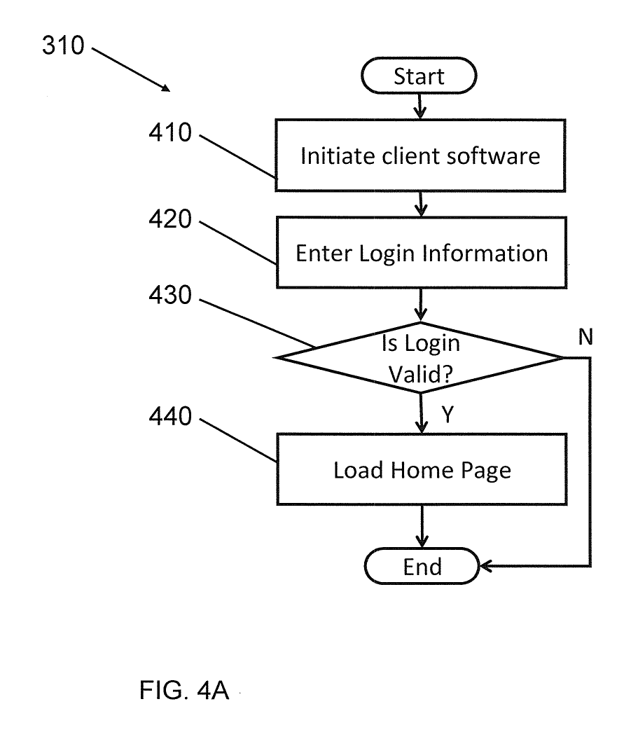

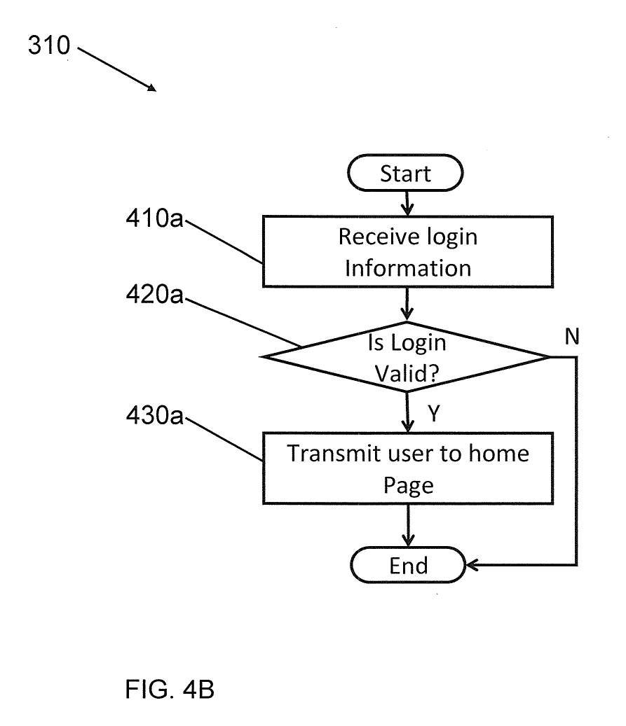

FIG. 4A illustrates one method by which the login process 310 is completed. A user may initiate 410 the client software, enter login information 420, receive a prompt regarding whether the login is valid 430, and view the home page 440. On the central server 10 side, as illustrated in FIG. 4B, the server 10 receives login information 410a, determines if the login information is valid 420a (e.g., by checking the login information against a user database), and transmitting 430a information associated with the user's home page to the client software.

Various aspects of a user interface for a central hub system according to embodiments of the present invention will be described hereafter.

In some embodiments of the present invention the human computer interface is implemented as a Web App such that a user can access the central hub system via a web browser. In other embodiments of the present invention, the human computer interface is implemented as a standalone, dedicated application running on, for example, Apple® devices (such as an iPhone®, an iPad®, or an iPod Touch®), a Research in Motion device (e.g., a Blackberry® device), a Google® device (e.g., a device running Android®), or other mobile devices.

1) Authentication and User Login

In one embodiment of the present invention, login is accomplished using an ASP.Net login component in communication with a Windows Active Directory. This login component collects the user's login username and password information and allows the system to set a cookie which remembers the user on a specific computer, allowing the user to skip the login page in the future. Once a username and password are submitted, the credentials are submitted to the Windows Active Directory. If a username with the associated password exists in the Active Directory a positive result is returned. Upon a successful Active Directory authentication, the username submitted is then used to obtain or determine the specific user rights that the user is entitled to from the a central database, at which point the user is redirected to the main menu (e.g., the user interface displays the main menu).

In one embodiment, the usernames and passwords are not stored in the central hub database, but rather in the Windows Active Directory such that login credentials for accessing the central hub system are synchronized and correspond to the user's network login.

The central hub system uses usernames to determine the user's security privileges. For example, users may have access to view or modify conditions of equipment controlled by the central hub system based on the privileges granted to the user's account. These privileges can be spread among multiple levels to distinguish what an individual can view and what and individual can edit, and these privileges may be granted on a per location or piece of equipment basis.

A login system according to one embodiment utilizes ASP.Net, Visual Basic, Microsoft Windows Active Directory, and Microsoft SQL Server.

2) System Administration Section

In embodiments of the present invention, the system administration section of the application allows administrative users (or administrators) to interface with the back-end SQL server to update information pertaining to users (e.g., to add, remove, or manage users). In addition, it allows administrative users to manage facilities, facility menus, and specific user facility access. Both the type of access and the access to individual facilities is controlled by the administrators.

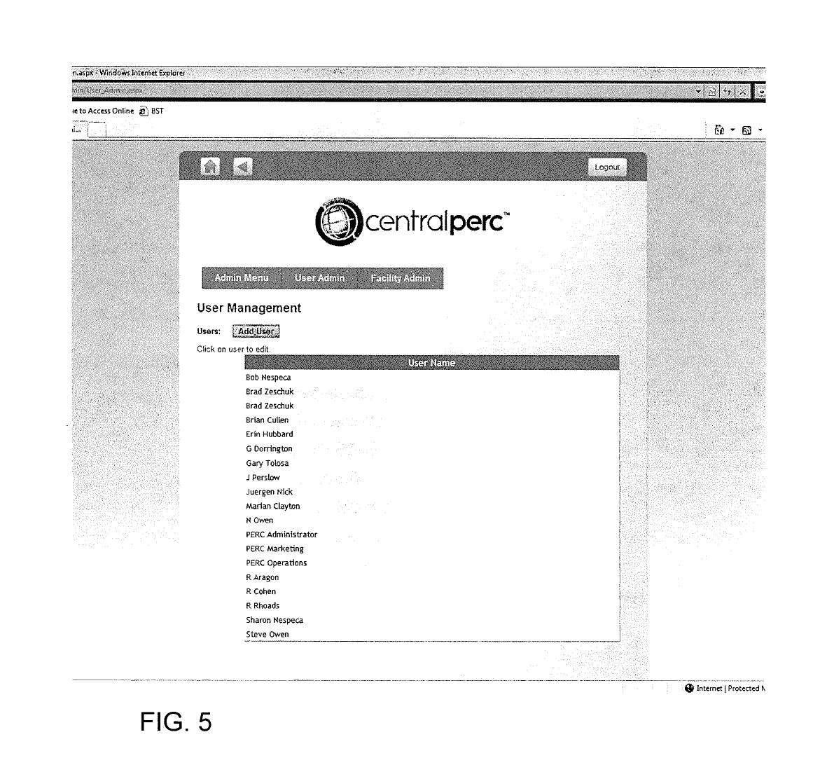

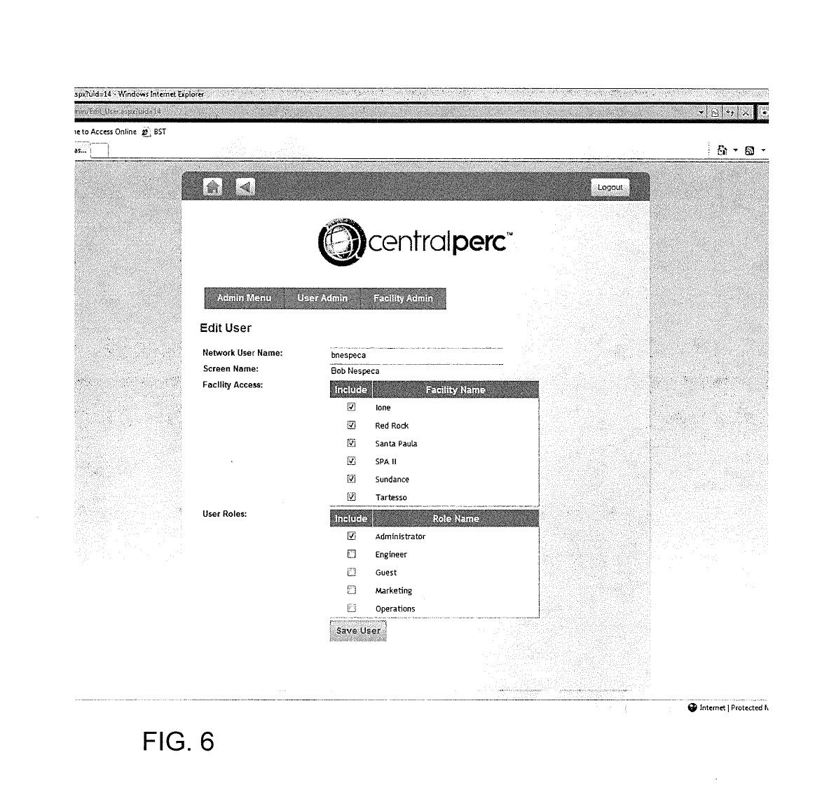

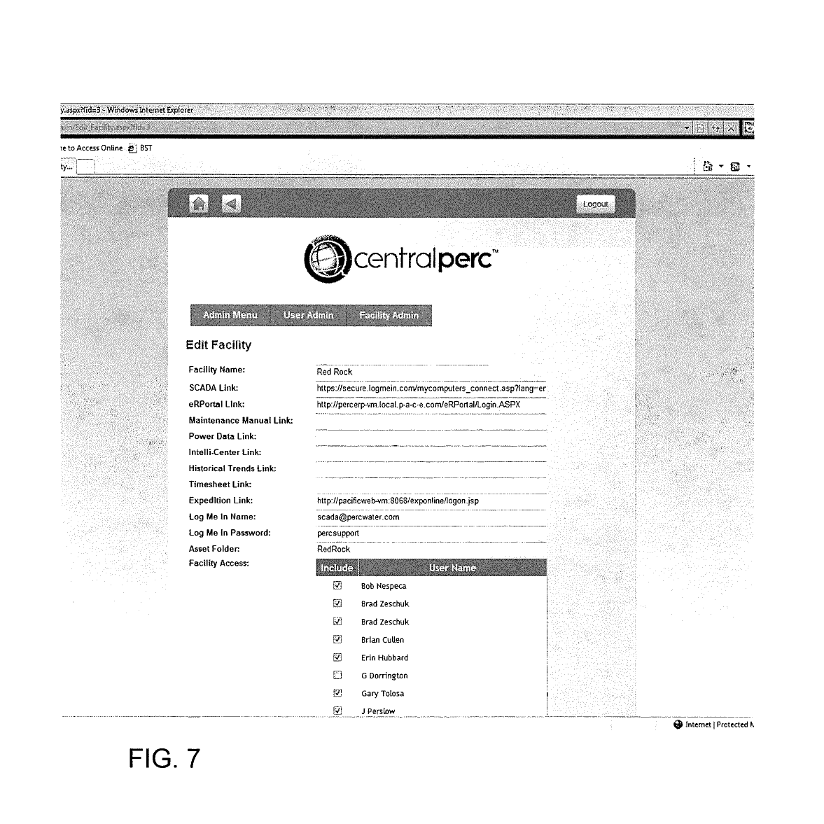

FIG. 5 is a screenshot of a user management administrative interface according to one embodiment of the present invention. FIG. 6 is a screenshot of a user permissions administrative interface according to one embodiment of the present invention. FIG. 7 is a screenshot of a facility information administrative interface according to one embodiment of the present invention.

In one embodiment of the present invention, the system administration section uses ASP.Net web-based forms and Visual Basic form processing to give the administrative user access to update or manage the Microsoft SQL server data tables which store information used in user rights assignment and facility information management.

Facility Reporting and Management

The main facilities menu and each facilities page includes menus dynamically generated based on the user's (e.g., the currently logged-in user's) privileges. This portion of the application allows users to view facility information, report facility statistics, and manage facility settings. These dynamically generated menus take into account each user's security level and facility access when displaying menu items as appropriate for the user's access privileges. Different versions of these dynamically generated menus are designed to be viewable on a variety of differently sized displays (e.g., smartphone, tablet, and personal computer sizes) and with interface elements suitable for a various input mechanisms (e.g., touch screen, stylus, keyboard and mouse).

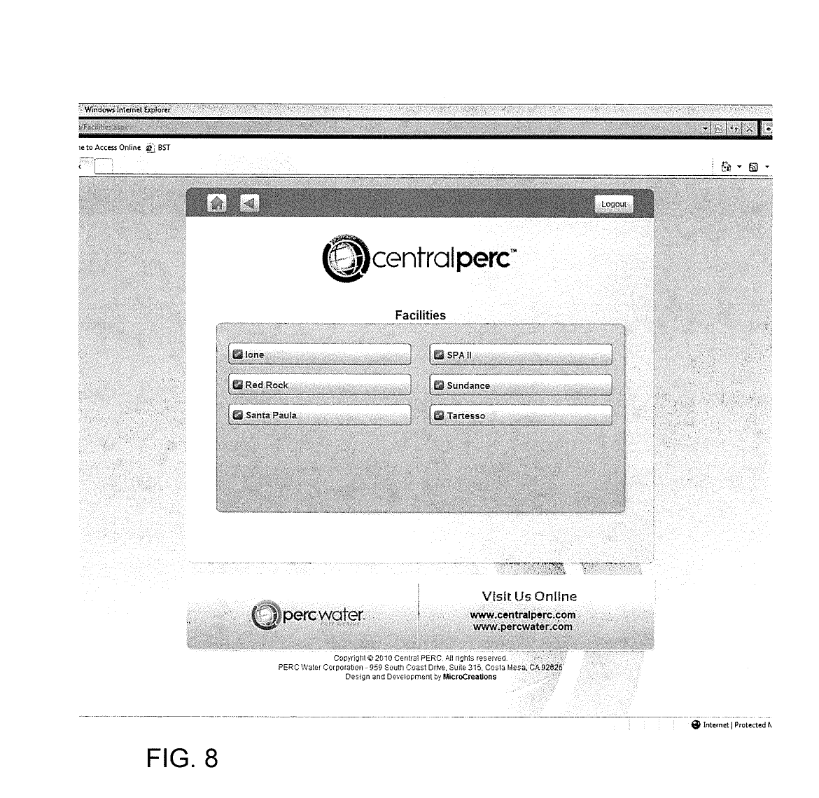

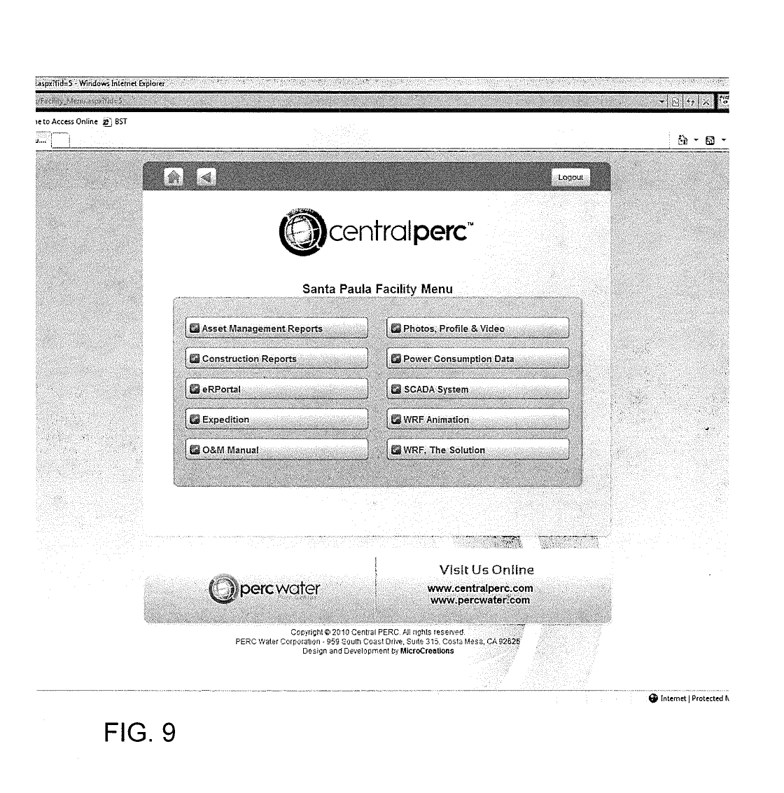

FIG. 8 is a screenshot of an interface for selecting a facility to monitor and control according to one embodiment of the present invention. FIG. 9 is a screenshot of a facility monitoring and control menu according to one embodiment of the present invention.

In one embodiment, these dynamically generated menus include (but are not limited to):

a) Documents—Asset management reports, power consumption records, construction reports, operations and safety material and facility photographs are available through the facilities menu via a document browsing and viewing system.

Several Document menus throughout the application are created dynamically based on documents uploaded to the system. For example, Employee Information, Water Industry News, Health and Safety, and Customized Design Reports menus are dynamically generated based on the documents stored in specific locations (e.g., directories shared over a network).

In addition, each facility may have its own directory of documents. Document types displayed in folders indexed to each facility include, but are not limited to: construction management reports, electricity use records, monthly asset management reports, Customized Design Reports®, and lab results. Operations & Maintenance Manuals for specific facilities can also be made available on the system. These manuals may be split into a number of documents (e.g., in PDF, HTML, or other formats) which are organized and managed in a manner similar to that of the other document types described above.

As administrators add or remove documents from the specific server folders the menus will automatically display links for documents in those locations. In addition, the user interface may display subdirectories within these locations as expandable folders.

As items are added or removed from these folders the menus automatically reflect these changes, allowing the system administrators to update menus simply by moving files or file folders into or out of the folders. The menu items which are created contain links to custom document viewer components, dependent on document type. For example, images may be opened using a photo viewer and PDFs may be opened using a PDF viewer. The document viewing components allow the user to view the document and also to navigate back to the main application menus.

According to one embodiment of the present invention, the above described documents are stored in one or more cloud storage systems or services such as Dropbox®, Google® Drive, and Amazon® S3.

For example, the Water Industry News section provides links to recent internet news items that pertain to the water industry. Users will be able to add to the listing themselves by uploading drawings or data to pages they have the authority to change.

Embodiments of the present invention also include a Document viewer to embed images or PDFs into the view while maintaining a system navigation menu along the top of the page.

b) Assets, purchasing, and financial information may be available via the central hub system. For example, these may be available through a third-party application (e.g., eRPortal™) for each facility. In some embodiments of the current invention, the current user (assuming the user has appropriate privileges) is automatically logged directly in to the third-party application for the corresponding facility.

c) Construction management information may also be available via the central hub system. For example, a link to a construction project management system (e.g., a Primavera® Expedition® system) would allow access to the corresponding facility. In some embodiments of the current invention, the current user (assuming the user has appropriate privileges) is automatically logged in to the construction project management system for the corresponding facility via passed a login. In another embodiment of the present invention, the data is supplied to the central hub system via a web service.

d) Facility Management—Each water treatment facility can be managed remotely by means of a SCADA system. The facilities menu is dynamically created based on the facilities in the central hub database. As facilities are added or removed from the system in the administration area the changes will be reflected in the menu system automatically. Access to each SCADA system is available through the specific facility menu. In one embodiment, the system uses remote desktop tool software (e.g., LogMeIn®, Virtual Network Computing®, and GoToMyPC®) to access the SCADA system of each facility. Depending on the facility set-up, access to these systems is made in one of two ways: If the facility has a single SCADA system, a remote desktop shortcut to that system is saved and then referenced from the central hub system. If the facility has more than one SCADA system, the user is directed to the remote desktop shortcut connection page for the central hub system, and the desired SCADA system connection can be made from that menu. The remote desktop system settings for each facility are managed in the administration section of the central hub system and stored in the database.

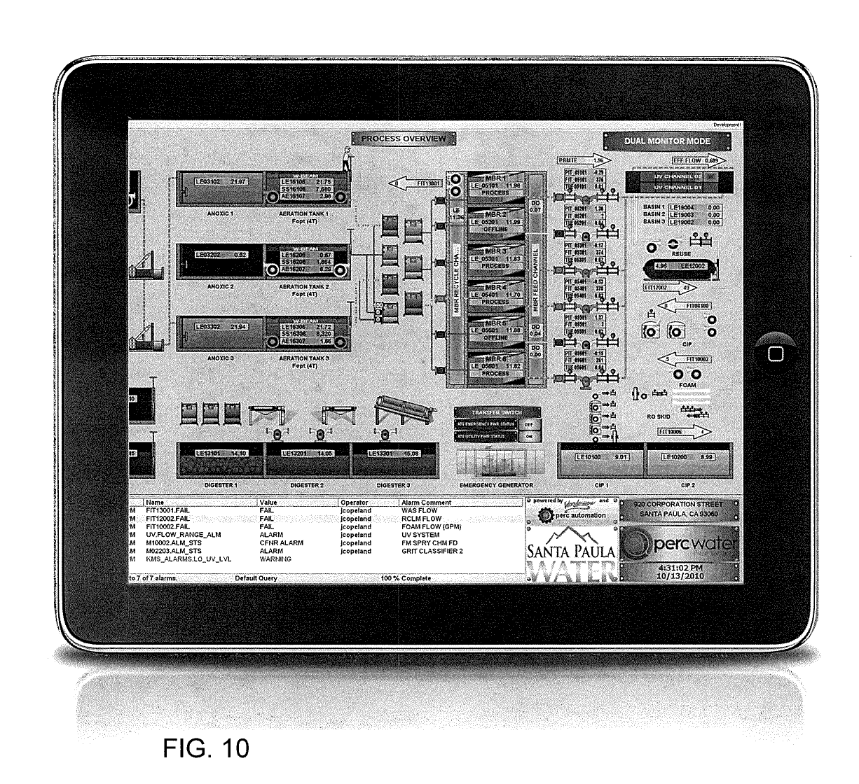

FIG. 10 is a screenshot of a facility monitoring interface displayed on a tablet computer according to one embodiment of the present invention.

In other embodiments of the present invention, no remote desktop tool is used for SCADA access and Active Directory is used to determine access rights.

Authorized users can use SCADA to control individual facilities operations using the remote desktop tool. From a distance, operators can witness events, correct operations, and head off potential disasters. For example, SCADA can be used to open and close valves, turn pumps on and off (or adjust their speeds), and make other physical changes. In some embodiments of the present invention, the system includes a converter configured to convert status information and commands between various formats. For example, a converter may be implemented using Extensible Stylesheet Language Transformatminos (XSLT) to translate status information in XML into XML having a different format for storage, translate stored status information from XML into HTML for display, or to convert commands received from a terminal device into a format recognized by the SCADA systems specific to the particular equipment installed at a facility.

e) Facility Videos—A video player is used to display video of current or past conditions at the facilities. Examples of suitable player software include Flowplayer™, VLC media player, and MPlayer.

f) Dashboard—A dashboard to display relevant facility based information in real time (or nearly real time) is fed directly from electronic devices at each facility. Flow rates, pollutant concentrations, electricity use and other dynamic quantities and qualities are displayed by intercepting the communication between the Programmable Logic Controller and SCADA. The graphics may be formatted in a standardized way to simplify comparisons of information between different sources. In addition, the dashboard system can be configured to generate alerts when specific conditions are reached (e.g., when the pH level of the water crosses a particular threshold). These alerts can be generated and sent to users based on their roles and access privileges. For example, a low priority alert affecting only a single facility may be sent only to users managing that single facility, while a high priority alert caused by a problem at one facility but affecting other facilities may be sent out to users managing all of the affected facilities.

A forum or discussion board within the system allows individuals to make suggestions for improvement. The collection of reported items is reviewed for themes and is helpful to designers, construction teams and those who make financial and operational decisions. Because it is possible for anyone to comment on the original suggestion, there is an exchange of ideas that would otherwise take place only when individuals make some form of direct contact. The forum is not anonymous and each suggestion is tagged to the reporter. When major issues arise, additional information can be attached to the original report allowing anyone to contribute their unique perspective to the parties making decisions.

In some embodiments of the present invention, the human computer interface is built as a web-based application to provide accessibility on computers, iPads, iPods, iPhones and any recent smart-phone or tablet device. ASP.Net 4.0 programmed in Visual Basic. HTML, and CSS may be used to display the pages and backgrounds and menu items may be images (e.g., PNG, JPEG, or GIF images). Back-end data is stored in a database such as Microsoft SQL Server 2005 running on a virtual installation of Windows 2008. User authentication is performed to verify appropriate access to information and controls. In one embodiment, this authentication is provided by an authentication server such as a Windows Network Active Directory.

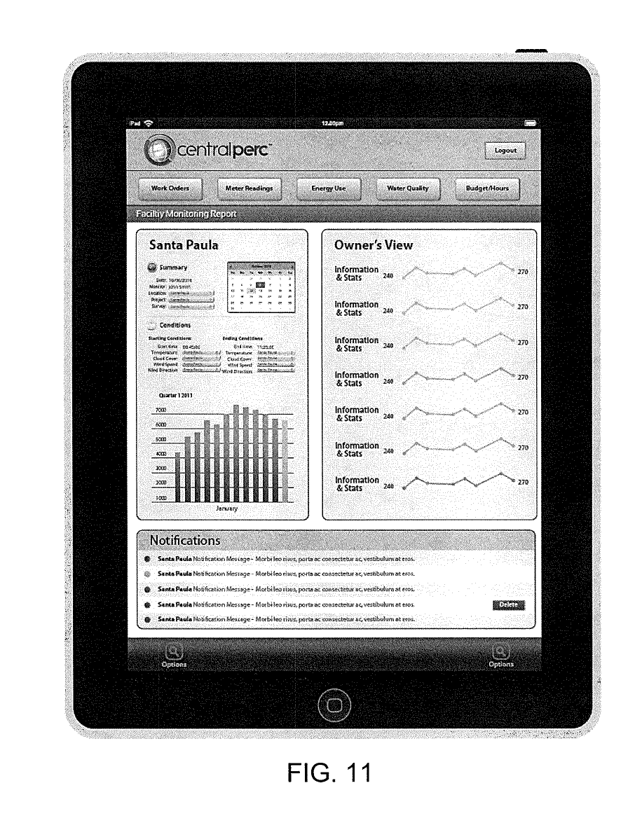

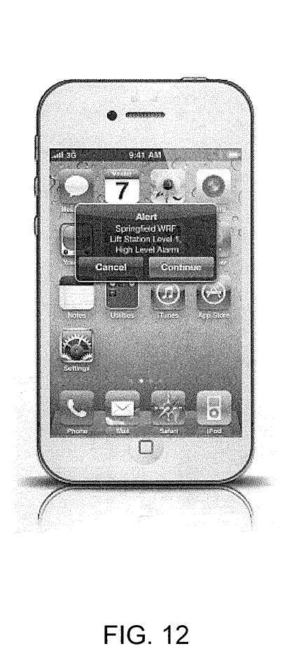

For example, FIGS. 11 and 12 illustrate a user interface for the system implemented on a smartphone or other small mobile device. FIG. 11 is a screenshot of a dashboard interface displayed on an iPad tablet according to one embodiment of the present invention. The elements of the dashboard illustrate the current alarms at a facility and provide graphs of recent measurement related to the facility. FIG. 12 is a screenshot of a text based notification of an alarm displayed on a smartphone according to one embodiment of the present invention.

While the present invention has been described in connection with certain exemplary embodiments, it is to be understood that the invention is not limited to the disclosed embodiments, but, on the contrary, is intended to cover various modifications and equivalent arrangements included within the spirit and scope of the appended claims, and equivalents thereof.

What is claimed is:

1. A system for remotely monitoring and controlling a plurality of water treatment facilities distributed over a wide area, the system comprising:
a plurality of interfaces configured to receive status information from the facilities and to transmit commands to control the facilities;
a database for storing the status information; and
a human machine interface configured to transmit the status information to a remote terminal.

2. The system of claim 1, wherein the interfaces are configured to communicate with a SCADA system of one of the facilities.

3. The system of claim 1, wherein the system is configured to store documentation regarding the plurality of facilities.

4. The system of claim 3, wherein the human machine interface is further configured to transmit the stored documentation to the remote terminal.

5. The system of claim 1, wherein the human machine interface is further configured to transmit combined data of more than one of the facilities to the remote terminal.

6. The system of claim 1, wherein the human machine interface is further configured to transmit historical data associated with the facilities to the remote terminal.

7. The system of claim 1, wherein the human machine interface is further configured to receive commands from the remote terminal and wherein the system is configured to transmit the received commands to a facility of the facilities.

8. The system of claim 7, wherein the received commands are adapted to control an asset at the facility and wherein the system is further configured to convert the received commands to a format corresponding to the asset at the facility.

9. The system of claim 1, further comprising a converter for converting status information to a common format.

10. A system for remotely monitoring and controlling a water treatment facility, the system comprising:
a plurality of interfaces configured to communicate with the facility, to receive status information from the facility, and to transmit commands to control the facility;
a database for storing the status information;
a human machine interface configured to transmit the status information to a remote terminal.

11. A method of remotely monitoring and controlling a plurality of facilities distributed over a wide area, the method at a central server comprising:
receiving status information from the facilities;
storing the status information; and
transmitting the status information to a remote terminal.

12. The method of claim 11, wherein the status information transmitted to the remote terminal comprises data from more than one of the facilities.

13. The method of claim 11, further comprising:
receiving a command from the remote terminal to control a facility of the facilities; and
sending the command to the facility of the facilities.

14. The method of claim 11, further comprising converting the status information into a common format.
